(19) United States
(12) Patent Application Publication
(10) Pub. No.: US 2026/0211929 A1
(43) Pub. Date: Jul. 23, 2026

(54) OPTIMIZATION FRAMEWORK FOR ENHANCING DOMAIN ADAPTATION OF GRAPHRAG VIA ENTITY-RELATION OPTIMIZATION

(71) Applicant: Oracle International Corporation, Redwood Shores, CA (US)

(72) Inventors: Neelesh Kumar Shukla, Bangalore (IN); Prabhat Kumar Prabhakar, Bangalore (IN); Sakthivel Thangaraj, Bengaluru (IN); Sandeep Singh, Bangalore (IN); Vijayalakshmi Krishnamurthy, Sunnyvale, CA (US); Weiyi Sun, Somerville, MA (US); Chandramouliswaran Prasanna Venkatesan, Seattle, WA (US)

(73) Assignee: Oracle International Corporation, Redwood Shores, CA (US)

(21) Appl. No.: 19/266,529

(22) Filed: Jul. 11, 2025

(30) Foreign Application Priority Data
Jan. 18, 2025 (IN) 202541004218

(51) Int. Cl. G06F 16/34; G06F 16/28

(52) U.S. Cl. CPC G06F 16/345; G06F 16/288

(57) ABSTRACT

Techniques are disclosed herein for summarizing complex and lengthy documents in various domains. In one aspect, a method includes: extracting, by a generative model, entities and their relationships from source content based on entity types and examples of entity relationships, generating, by a generative model, a network graph based on the extracted entities and their relationships, and generating, by a generative model, one or more summaries of the source content based on the source content and the network graph. The summaries are then evaluated using an optimizer generative model, optimizer prompt, and objective function against ground truth summaries. One or more recommendations are generated based on the evaluation to improve one or more prompts used for extracting the entities and their relationships from source content to better align entities and their relationships with specified objectives.

### CROSS-REFERENCE TO RELATED APPLICATION

The present application is a non-provisional application of and claims the benefit and priority of Indian Provisional Application No. 202541004218, filed on Jan. 18, 2025, the entire contents of which is incorporated herein by reference in its entirety for all purposes.

### FIELD

The present disclosure relates generally to natural language processing (NLP), machine learning, and document summarization, and more particularly, to retrieval-augmented generation (RAG) techniques for summarizing complex and lengthy documents in various domains.

### BACKGROUND

Document summarization is the process of creating a concise and coherent version of a longer text document while preserving its most important information and overall meaning. This task can be accomplished using advanced natural language processing techniques, particularly large language models (LLMs) like those based on the GPT architecture. These models are trained on large datasets, which allows them to understand the structure, context, and semantics of language at a high level. The goal of document summarization is to help readers quickly grasp the key points of a document without having to read the entire text, making it especially useful for legal, academic, or business contexts where time and clarity are important.

There are two main approaches to document summarization: extractive and abstractive. Extractive summarization involves selecting and compiling the most relevant sentences or phrases directly from the original text, ensuring that the summary remains accurate and closely aligned with the source material. Abstractive summarization, in contrast, involves generating new sentences that paraphrase and synthesize the main ideas from the document, often requiring a deeper understanding and reinterpretation of the content. Large language models excel at both approaches by being able to analyze the context, identify important themes, and produce clear, coherent summaries tailored to the needs of the user.

### SUMMARY

Large language models have shown promise in summarizing complex documents, but their limitations in handling lengthy documents and capturing global information hinder their performance in tasks like Query-Focused Summarization (QFS). To address these limitations, GraphRAG was investigated to improve the summarization of complex documents. GraphRAG is a retrieval augmented generation approach that utilizes a globally summarized knowledge graph derived from an LLM. GraphRAG was applied to the Financial Narrative Summarization (FNS) dataset, which is comprised of lengthy financial reports. The results show that a naive RAG approach outperforms GraphRAG in terms of comprehensiveness, directness, conciseness and completeness. However, it was discovered that optimizing entity and relation extraction using an LLM as an optimizer can enhance GraphRAG's performance. This disclosure highlights the need for domain-specific optimization to improve GraphRAG's capabilities for summarization tasks in facts-heavy domains like finance. The optimization framework described in detail herein extends GraphRAG's original domain adaptation strategy by incorporating entity and relations optimization, leading to improved performance in capturing relevant entities and relationships. These findings contribute to the development of more effective summarization models for complex documents in finance and other domains.

In various embodiments, a computer-implemented method is provided that comprises: determining, by a first generative model, entity types relevant to a domain based on an entity type generation prompt comprising the domain, a persona, and a sample of source content; generating, by a second generative model, examples of relationships among entities within the domain based on an entity relationship example generation prompt comprising the entity types and the sample of the source content; extracting, by a third generative model, entities and their relationships from the source content based on an entity and relationship extraction prompt comprising the entity types and the examples of relationships; generating, by the third generative model, a network graph based on the extracted entities and their relationships; generating, by a fourth generative model, one or more summaries of the source content based on the source content and the network graph; evaluating, by a fifth generative model and based on an optimizer prompt and objective function, the generated one or more summaries against ground truth summaries; generating, by the fifth generative model, one or more recommendations to improve the entity type generation prompt, the entity relationship example generation prompt, the entity and relationship extraction prompt, or any combination thereof to align entities and their relationships with specified objectives; and modifying the entity type generation prompt, the entity relationship example generation prompt, the entity and relationship extraction prompt, or any combination thereof based on the one or more recommendations.

In some embodiments, the computer-implement method further comprises generating, by a sixth generative model, the domain and the persona for the sample of the source content based on a domain and persona generation prompt comprising the sample of source content.

In some embodiments, one or more of the first generative model, the second generative model, the third generative model, the fourth generative model, and the sixth generative model are the same or different generative models.

In some embodiments, the first generative model, the second generative model, the third generative model, the fourth generative model, and the sixth generative model are the same generative model.

In some embodiments, the objective function is expressed as a set of instructions within the optimizer prompt, and wherein the set of instructions cause the fifth generative model to compare the generated one or more summaries against ground truth summaries and analyze performance of the third generative model to extract the entities and their relationships from the source content based on the compare.

In some embodiments, analyzing the performance of the third generative model may include identifying errors in extracting the entities and their relationships from the source content based on the comparing and with attention to improving one or more metrics for measuring quality of the one or more summaries.

In some embodiments, the one or more metrics include comprehensiveness, directness, completeness, conciseness, or any combination thereof.

In some embodiments, the set of instructions further cause the fifth generative model to generate instructions, based on the analyzing and the one or more metrics, as the one or more recommendations to improve the entity type generation prompt, the entity relationship example generation prompt, the entity and relationship extraction prompt, or any combination thereof to align entities and their relationships with the specified objectives.

In some embodiments, the one or more recommendations are to improve the entity type generation prompt, the modifying comprises generating an optimized entity type generation prompt based on the one or more recommendations, and the generating the optimized entity type generation prompt comprises including one or more specific entity types relevant to the domain for a task of summarization in the entity type generation prompt.

In some embodiments, the computer-implement method further comprises: determining, by the first generative model, entity types relevant to another domain based on the optimized entity type generation prompt comprising the another domain, a persona, and a sample of another source content; generating, by the second generative model, examples of relationships among entities within the domain based on the entity relationship example generation prompt comprising the entity types and the sample of the another source content; extracting, by a third generative model, entities and their relationships from the another source content based on the entity and relationship extraction prompt comprising the entity types and the examples of relationships; generating, by the third generative model, another network graph based on the extracted entities and their relationships; and generating, by a fourth generative model, one or more summaries of the another source content based on the another source content and the network graph.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 shows an example of an Entity and Relationship Extraction Prompt in accordance with various embodiments.

FIG. 2 shows a block diagram of Domain Adaptation Flow: GraphRAG's Auto-Tuning Process (dashed line) and an Optimized Auto-Tuning Approach Utilizing a Generative Model as an Optimizer (double line) in accordance with various embodiments.

FIG. 3 is an illustration of a two-step summarization in accordance with various embodiments.

FIG. 4 is a simplified diagram of an AI-enabled system that provides various services to users, according to various embodiments.

FIG. 5 depicts a block diagram of an example computing environment of a summary generation system configured to automatically generate summaries for various content to be summarized, according to various embodiments.

FIG. 6 is a flowchart illustrating a process for optimized auto-tuning approach utilizing a generative model as an optimizer, according to various embodiments

FIG. 7 is a block diagram illustrating one pattern for implementing a cloud infrastructure as a service system, in accordance with various embodiments.

FIG. 8 is a block diagram illustrating another pattern for implementing a cloud infrastructure as a service system, in accordance with various embodiments.

FIG. 9 is a block diagram illustrating another pattern for implementing a cloud infrastructure as a service system, in accordance with various embodiments.

FIG. 10 is a block diagram illustrating another pattern for implementing a cloud infrastructure as a service system, in accordance with various embodiments.

FIG. 11 is a block diagram illustrating an example computer system, in accordance with various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

### Technical Problem

Large Language Models (LLMs) have shown promise in analyzing complex documents and generating summaries, but they face significant challenges in summarizing lengthy documents due to restrictions on their context windows. The expansion of such windows may not be enough given that information can be “lost in the middle” of longer contexts (Nelson F. Liu, Kevin Lin, John Hewitt, Ashwin Paranjape, Michele Bevilacqua, Fabio Petroni, and Percy Liang. 2024. Lost in the middle: How language models use long contexts. Transactions of the Association for Computational Linguistics, 12:157-173). Retrieval-augmented generation (RAG) is a method that can overcome these limitations (Patrick Lewis, Ethan Perez, Aleksandra Piktus, Fabio Petroni, Vladimir Karpukhin, Naman Goyal, Heinrich Kuttler, Mike Lewis, Wen-tau Yih, Tim Rocktaschel, Sebastian Riedel, and Douwe Kiela. 2020. Retrieval-augmented generation for knowledge intensive nlp tasks. In Proceedings of the 34th International Conference on Neural Information Processing Systems, NIPS '20, Red Hook, NY, USA. Curran Associates Inc.), but it struggles with capturing global information and addressing global queries, such as ‘What are the main themes in the dataset?’ This limitation, particularly its inability to effectively capture global information hinders its performance in tasks such as Query-Focused Summarization (QFS), where a broader understanding of the data is necessary (Boci Peng, Yun Zhu, Yongchao Liu, Xiaohe Bo, Haizhou Shi, Chuntao Hong, Yan Zhang, and Siliang Tang. 2024. Graph retrieval-augmented generation: A survey. Preprint, arXiv:2408.08921). To address these challenges, retrieval-augmented generation (RAG) methods, particularly GraphRAG, have been introduced (Darren Edge, Ha Trinh, Newman Cheng, Joshua Bradley, Alex Chao, Apurva Mody, Steven Truitt, and Jonathan Larson. 2024. From local to global: A graph rag approach to query-focused summarization). GraphRAG leverages a globally summarized knowledge graph generated by an LLM to enhance summarization capabilities. Despite these advances in capturing global information, GraphRAG struggles to perform optimally due to static domain adaptation techniques and suboptimal entity-relation extraction processes.

### Technical Solution

In order to address these challenges and others, a novel optimization framework is described herein that enhances the performance of GraphRAG for domain-specific tasks such as summarization tasks, especially in fact-heavy domains like finance. The framework incorporates a generative model (e.g., an LLM) as an optimizer to refine entity and relation extraction processes. The generative model does this by iteratively generating and implementing recommendations to improve an ‘Entity Type Generation Prompt’ to align generated entities and relationship with the specified objectives. By optimizing these components, the framework extends GraphRAG's domain adaptation strategy, leading to improved performance including accuracy and comprehensiveness in summarizing lengthy and complex documents. Moreover, optimization of the ‘Entity Type Generation Prompt’ plays an important role in optimizing the technical performance of other generative models in the framework, particularly in terms of CPU and GPU utilization. When prompts are well-structured and clearly convey the intent, the generative models can more efficiently parse and process the request, reducing the computational overhead associated with ambiguous or overly broad queries that might trigger unnecessary or resource-intensive inference paths. This efficiency stems from the models' ability to narrow its focus, limit the breadth of its internal search space, and avoid generating extraneous content, thereby accelerating response times (reducing latency) and lowering the number of processing cycles needed per request. In large-scale deployments or latency-sensitive applications, such as those common in financial and technical domains, improved prompt engineering can translate directly into reduced operational costs, better throughput, and more predictable system performance, all while maintaining or enhancing the quality of the models' outputs.

More specifically, the framework is built upon the observation that static prompt-based approaches for domain adaptation in GraphRAG often fail to capture nuanced dataset relationships. To address this, the framework introduces the following key aspects.

### Dynamic Optimization of Entity and Relation Extraction:

A generative model such as an LLM is used as an optimizer to iteratively refine the extraction of entities and their relationships within the input documents using training data.
This optimization enables the generation of a more accurate and contextually relevant entity relationship graph.

### Enhanced GraphRAG Domain Adaptation Framework:

The original domain adaptation strategy in GraphRAG is extended to include dynamic entity-relation optimization.
This enhancement allows for better alignment with the complexities of data such as financial data, improving GraphRAG's summarization capabilities.

### Advantages:

Improved Performance: The optimization framework significantly enhances GraphRAG's ability to handle domain-specific summarization tasks.
Dynamic Adaptation: Unlike static prompt-based approaches, the proposed method dynamically adapts to nuanced dataset relationships, improving relevance and accuracy.
Scalability: The framework is applicable to various fact-heavy domains beyond finance, such as healthcare, law, and scientific literature.

In an illustrative embodiment, a computer-implemented method is provided that comprises determining, by a first generative model, entity types relevant to a domain based on an entity type generation prompt comprising the domain, a persona, and a sample of source content; generating, by a second generative model, examples of relationships among entities within the domain based on an entity relationship example generation prompt comprising the entity types and the sample of the source content; extracting, by a third generative model, entities and their relationships from the source content based on an entity and relationship extraction prompt comprising the entity types and the examples of relationships; generating, by the third generative model, a network graph based on the extracted entities and their relationships; generating, by a fourth generative model, summaries of the source content based on the source content and the network graph; evaluating, by a fifth generative model and based on an optimizer prompt and objective function, the generated summaries against ground truth summaries; generating, by the fifth generative model, one or more recommendations to improve the entity type generation prompt, the entity relationship example generation prompt, the entity and relationship extraction prompt, or any combination thereof to align entities and their relationships with specified objectives; and modifying the entity type generation prompt, the entity relationship example generation prompt, the entity and relationship extraction prompt, or any combination thereof based on the one or more recommendations. In some instance, one or more of the first generative model, the second generative model, the third generative model, the fourth generative model, and the sixth generative model are the same or different generative models. In some instances, the first generative model, the second generative model, the third generative model, the fourth generative model, and the sixth generative model are the same generative model.

As used herein, when an action is “based on” something, this means the action is based at least in part on at least a part of the something.

As used herein, the terms “similarly,” “substantially,” “approximately” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1, 1, 5, and 10 percent.

### Detailed Technical Solution

### A) Key Areas of Focus:

Analysis of GraphRAG on financial narratives: Previous research has explored the effectiveness of GraphRAG on datasets comprising podcast transcripts and news articles (Darren Edge, Ha Trinh, Newman Cheng, Joshua Bradley, Alex Chao, Apurva Mody, Steven Truitt, and Jonathan Larson. 2024. From local to global: A graph rag approach to query-focused summarization). Aspects of the present disclosure aim to broaden the scope by investigating the effectiveness of GraphRAG-based query-focused summarization in fact-rich domains such as finance. Specifically, GraphRAG was applied to the Financial Narrative Summarization (FNS) shared task (Elias Zavitsanos, Aris Kosmopoulos, George Giannakopoulos, Marina Litvak, Blanca Carbajo-Coronado, Antonio Moreno-Sandoval, and Mo El-Haj. 2023. The financial narrative summarization shared task (fns 2023). In 2023 IEEE International Conference on Big Data (BigData), pages 2890-2896.) which involves summarizing lengthy financial documents, such as annual reports around narrative sections. This makes this an ideal case study for the GraphRAG approach. The complexity of financial reports, characterized by technical terminology, numerical data, and domain-specific jargon, presents an ideal test case for GraphRAG's capabilities.

Optimizing domain adaptation: in accordance with aspects of the present disclosure, an optimization framework is described to enhance the performance of GraphRAG by incorporating entity and relation optimization. This framework ensures better alignment between ground-truth summaries and generated summaries with respect to an objective function, using a generative model such as an LLM as an optimizer.

### B) Overview of Financial Narrative Summarization 2023 Dataset

The FNS 2023 task dataset has been extracted from annual financial reports in PDF file format. The reports were written in English, Spanish, and Greek. For the dataset compilation, two to three people had to work for each language. For this work, an English dataset was used which contains approximately 4,000 UK annual reports for firms listed on LSE, covering the period between 2002 and 2022 (Mahmoud El-Haj, Paul Rayson, Steve Young, and Martin Walker. 2014. Detecting document structure in a very large corpus of UK financial reports. In Proceedings of the Ninth International Conference on Language Resources and Evaluation (LREC'14), pages 1335-1338, Reykjavik, Iceland. European Language Resources Association (ELRA).; Mahmoud El-Haj, Paul Rayson, and Nadhem Zmandar, editors. 2022. Proceedings of the 4th Financial Narrative Processing Workshop @LREC2022. European Language Resources Association, Marseille, France). In total, there are 4,013 annual reports divided into training, testing, and validation sets. Table 1 shows the dataset details.

TABLE 1
FNS 2023 Shared Task English Dataset

| Data Type | Train | Validation |
|---|---|---|
| Report Full-Text | 3050 | 413 |
| Gold Summaries | 10.007 | 1383 |

### C) Background of GraphRAG and It's Domain Adaptation

### 1. Default GraphRAG:

GraphRAG is an advanced retrieval-augmented generation (RAG) framework that integrates knowledge graphs with large language models (LLMs) to enhance the accuracy, relevance, and explainability of generated responses. Unlike traditional RAG approaches, which typically rely on retrieving and synthesizing unstructured text from document corpora, GraphRAG leverages the structured relationships and entities encoded in a knowledge graph to guide both the retrieval process and the generation of answers. More specifically, this graph allows GraphRAG to utilize the semantic structure of the data to respond to complex queries, offering a broad contextual understanding. The process of creating this graph, known as indexing, involves guiding a generative model such as an LLM through the source content using domain-specific prompts. The LLM extracts relevant entities and relationships to form the graph. Key prompts used during the indexing process include: A) Entity and relationship extraction: Identifies entities and defines the relationships between them; B) Entity and relationship summarization: Merges instances of entities and relationships into a concise description; and C) Community report generation: Provides summary reports for each community within the graph.

By mapping user queries to nodes and edges within the graph, GraphRAG enables the LLM to ground its outputs in explicit, verifiable data, facilitating multi-hop reasoning, richer contextual understanding, and more reliable citation of sources. This methodology is particularly valuable in technical and domain-specific applications—such as financial, scientific, or enterprise contexts—where precision, traceability, and the ability to explain the provenance of information are paramount. Through this synthesis of symbolic and neural methods, GraphRAG represents a significant step forward in making generative models such as LLMs both more powerful and trustworthy for complex information tasks.

### 2. GraphRAG's Approach for Domain Adaptation:

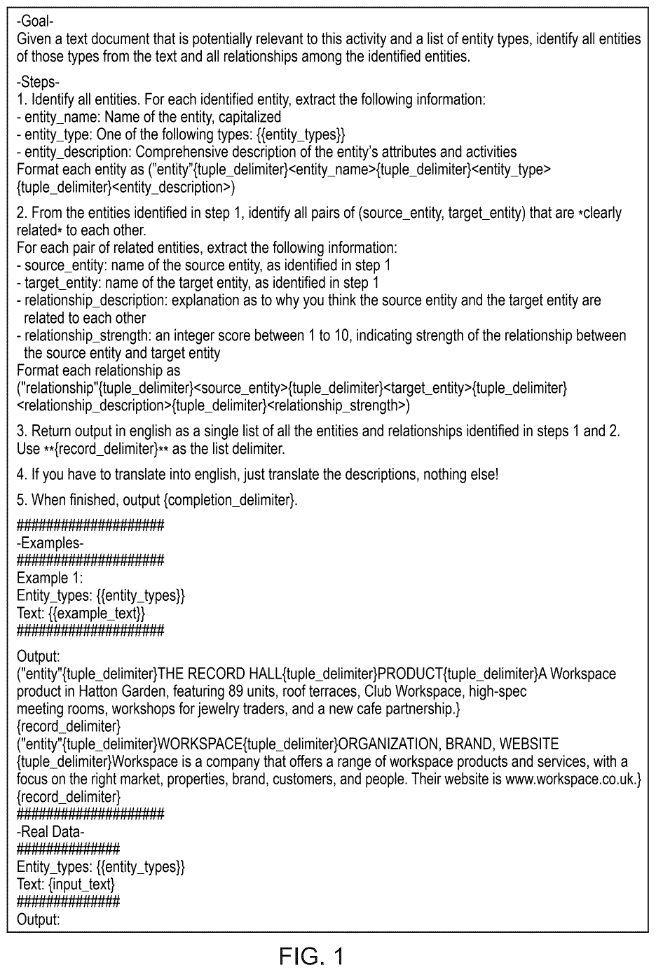

Each domain possesses unique entity and relationship types, rendering manual prompt creation a time-intensive process. To address this, an automated approach was developed for generating and refining domain-specific prompts efficiently. Consider the example of auto-tuning a prompt for ‘Entity and Relationship Extraction’. This prompt incorporates components including: entity and relationship extraction instructions, few shot examples, and real data placeholders. An example of an Entity and Relationship Extraction Prompt is illustrated in FIG. 1.

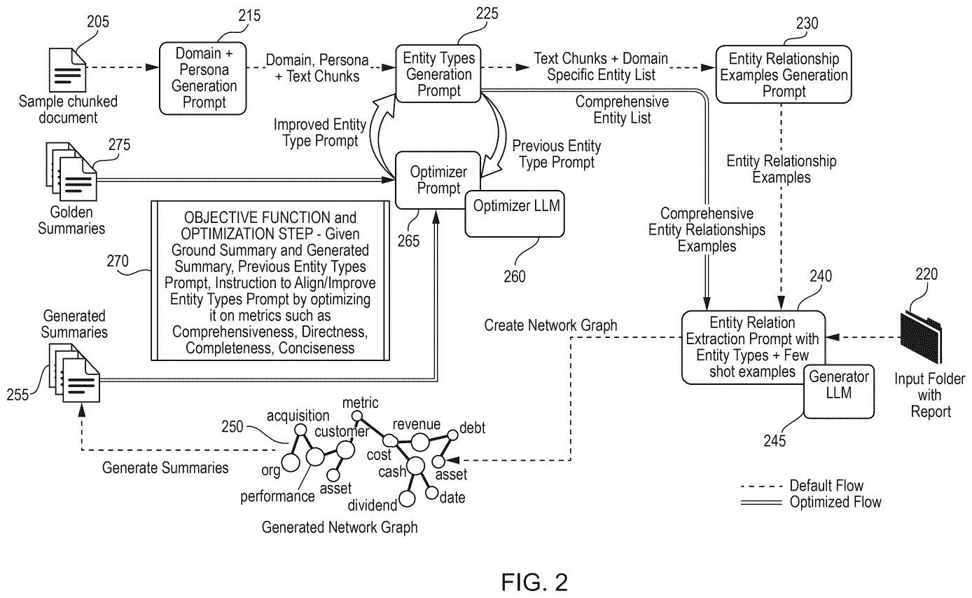

The workflow, illustrated in ‘dashed line’ (default flow) in FIG. 2 demonstrates this approach. To begin, a sample 205 of source content is provided to an LLM as part of a Domain and Persona Generation prompt 215 to identify the domain of the source content and define a suitable persona. The source content can be acquired from content 220 (e.g., training data or production data such as one or more financial reports) to be used for generating a knowledge graph. The persona generated by the LLM is to be considered suitable for a given task or intent such as document summarization. The domain, persona and sample 205 are subsequently input into an Entity Type Generation prompt 225. The Entity Type Generation prompt 225 is provided to the LLM to determine entity types relevant to the identified domain based on the persona. The following are example entity types identified using this methodology. Entity Types: [organization, market, location, financial metric, product, time]. Next, these domain-specific entity types and sample 205 are input into an Entity Relationship Example Generation prompt 230. The Entity Relationship Example Generation prompt 230 is provided to the LLM to generate representative examples of relationships among entities within the domain. Finally, the extracted entity types and relationship examples (i.e., few shot examples) are combined to construct a comprehensive Entity and Relationship Extraction prompt 240. The Entity and Relationship Extraction prompt 240 is provided to a Generator LLM 245 to construct a knowledge graph 250 by extracting entities (nodes) and their relationships (edges) from any given text, e.g., text in content 220 using techniques like named entity recognition and relationship extraction. Each node represents a unique entity (e.g., people, organizations, etc.), and edges capture the specific connections between them (e.g., “employed by” “asset of”). This process results in a structured, interconnected graph that can be continuously enriched and refined as more entities and relationships are learned and extracted.

### D) Optimizing Domain-Adaptation: Integrating LLM-as Optimizer and Ground Truth Summaries

The sole dependence on domain knowledge and persona-based methods for entity type identification is inadequate in capturing the dynamic nature of real-world data. While domain knowledge offers a baseline understanding and persona customization improves prompt design, these static strategies fall short in accommodating the intricate relationships and variations inherent in diverse datasets. To overcome this limitation, the approach described herein integrates GraphRAG's domain adaptation with various content data (e.g., content 220 described with respect to FIG. 2), leveraging ground truth summaries to enhance entity type recognition for enhanced domain-adaptation. The approach employs one or more generative models such as LLMs as an optimizer (Optimizer LLM), framing the optimization function and task through natural language instructions. This enables the dynamic refinement of prompts, adapting them to the specific context and data nuances. By integrating this optimization process, the goal of the approach is to achieve a more accurate and adaptable entity type identification.

In an illustrative embodiment, the Optimizer Prompt for Optimizer LLM is designed in a three-step manner:
Comparison and Error Identification: Similar to traditional machine learning, Optimizer LLM is asked to compare the golden summary (actual output) with the generated summary (predicted output) to identify missing entities, relationships, or facts.
Objective Function and Analysis: In this step, the objective of Optimizer LLM is to analyze the identified errors with focus on improving specific metrics, such as comprehensiveness, directness, completeness, and conciseness.
Instruction Generation: Based on the analysis and insights including the metrics from the previous step, Optimizer LLM is asked to generate instructions (e.g., modify the one or more prompts such as the Entity Type Generation prompt) to enhance the entity relation extraction process in subsequent iterations, thereby leading to improved summary generation.

The optimizer prompt and objective function expressed via instruction that can be used in this approach are as follows:

### Optimizer Prompt and Objective Function:

Compare the GENERATED_SUMMARY with the GOLDEN_SUMMARY to assess how well the entities, and relationships were extracted and captured.
Determine why these entities or relationships might have been missed.
Make modifications to the ENTITY_TYPES_PROMPT that would improve the extraction of entities and relationships in the next iteration, based on the optimization metrics provided (e.g., Comprehensiveness, Directness, Completeness, and Conciseness)

With respect back to FIG. 2, in ‘double line’, an iterative process begins with the Generator LLM 245 generating summaries 255 based on <Report Chunks, Ground Summaries> in training data 220, utilizing original GraphRAG's domain adaptation technique described above. Subsequently, the Optimizer LLM 260, guided by an outlined optimizer prompt 265 and objective function 270 (describe above), evaluates the generated summaries 255 against ground truth summaries 275, iteratively generating recommendations to improve one or more of the prompts used in the original GraphRAG's domain adaptation technique such as the Entity Type Generation prompt 225 (illustrated in FIG. 2) to align generated entities and relationship with the specified objectives. An illustrative example of a specified objective is shown in FIG. 2, 270: Given ground summary and generated summary, previous entity type prompt, Generate instructions to align/improve entity type generation prompt which optimizes metrics such as Comprehensiveness, Directness, Completeness and Conciseness. This adaptive approach ensures a continuous improvement in entity type identification, leading to enhanced precision, an increased alignment with domain-specific objectives, and improved technical performance of the LLMs.

Below are examples of the final suggestions generated by the Optimizer LLM 260 for refining the Entity Type Generation prompt 225, along with the identified entity types:

### Recommendations for Prompt Refinement:

To improve the entity extraction prompt, I suggest modifying the ENTITY_TYPES_PROMPT
   The user's task is to analyze the financial report and extract relevant entities and relationships.
   To include more specific entity types relevant to the task such as company, acquisition, financial metric, product, location, CEO, division, market, revenue, operating profit, cash generation, ROCE, health and safety, footprint, integration
   Change task in Real data section as: REAL DATA: Task: Analyze the financial report and extract relevant entities and relationships.

### Entity Types:

[organization, financial_report, metric, location, person, date, investment, revenue, customer, product, website, property, brand, safety, certification, acquisition, debt, employee, factory, construction, asset, cost, strategy, cash, dividend, drilling, committee, principle, environmental_impact, growth, appointment, performance, acquisition, sales]

### E) Experiment Setup

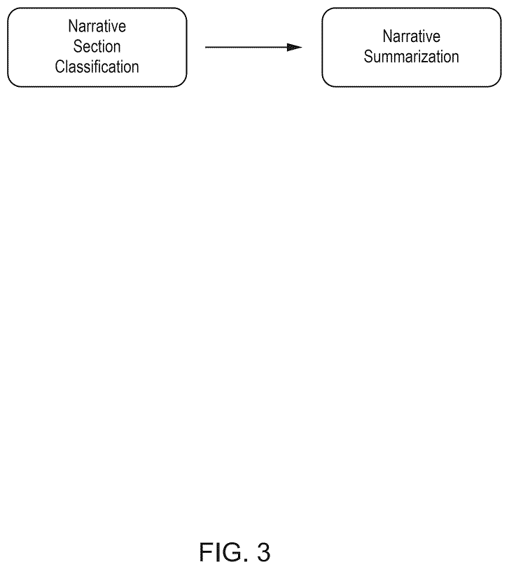

Instead of summarizing the complete report, the FNS task requires locating key narrative sections found in the annual reports and generate a single structured summary for them in not more than 1000 words (see FIG. 3). DiMSum (Neelesh Shukla, Amit Vaid, Raghu Katikeri, Sangeeth Keeriyadath, and Msp Raja. 2022. DiMSum: Distributed and multilingual summarization of financial narratives. In Proceedings of the 4th Financial Narrative Processing Workshop @LREC2022, pages 65-72, Marseille, France. European Language Resources Association) was utilized for narrative section identification and extraction. This system was the top performer in the FNS 2023 task (Elias Zavitsanos, Aris Kosmopoulos, George Giannakopoulos, Marina Litvak, Blanca Carbajo-Coronado, Antonio Moreno-Sandoval, and Mo El-Haj. 2023. The financial narrative summarization shared task (fns 2023). In 2023 IEEE International Conference on Big Data (BigData), pages 2890-2896.).

### Query

To evaluate the effectiveness of RAG systems on FNS task, a query was formed that conveyed the task requirement and only a high-level understanding of dataset contents.
Query: Please extract narrative summary of [COMPANY NAME]'s annual financial report in not more than 1000 words.

### Evaluation Metrics

Large Language Models (LLMs) have been shown to be effective in evaluating natural language generation, achieving results comparable to human judgments (Jiaan Wang, Yunlong Liang, Fandong Meng, Zengkui Sun, Haoxiang Shi, Zhixu Li, Jinan Xu, Jianfeng Qu, and Jie Zhou. 2023. Is ChatGPT a good NLG evaluator? a preliminary study. In Proceedings of the 4^{th} New Frontiers in Summarization Workshop, pages 1-11, Singapore. Association for Computational Linguistics; and Lianmin Zheng, Wei-Lin Chiang, Ying Sheng, Siyuan Zhuang, Zhanghao Wu, Yonghao Zhuang, Zi Lin, Zhuohan Li, Dacheng Li, Eric P. Xing, Hao Zhang, Joseph E. Gonzalez, and Ion Stoica. 2024. Judging llm-as-a-judge with mt-bench and chatbot arena. In Proceedings of the 37th International Conference on Neural Information Processing Systems, NIPS '23, Red Hook, NY, USA. Curran Associates Inc.). To assess the quality of generated text, four metrics were employed that utilize LLMs as evaluators.
For direct comparison, two metrics were adapted from GraphRAG for FNS task:
   Comprehensiveness: Does the system summary adequately cover all relevant details found in the human summaries? Evaluate how well it captures the breadth and depth of key information.
   Directness: How concise and straightforward is the system summary? Assess the extent to which it clearly and effectively distills the essential points from the human summaries without unnecessary complexity.

Additionally, FineSurE (Hwanjun Song, Hang Su, Igor Shalyminov, Jason Cai, and Saab Mansour. 2024. FineSurE: Fine-grained summarization evaluation using LLMs. In Proceedings of the 62nd Annual Meeting of the Association for Computational Linguistics (Volume 1: Long Papers), pages 906-922, Bangkok, Thailand. Association for Computational Linguistics) was used, a fine-grained summarization evaluation approach that leverages LLMs to evaluate summary quality at a detailed level. This method identifies key facts utilizing LLMs, which are concise sentences conveying a single piece of information (Manik Bhandari, Pranav Narayan Gour, Atabak Ashfaq, Pengfei Liu, and Graham Neubig. 2020. Reevaluating evaluation in text summarization. In Proceedings of the 2020 Conference on Empirical Methods in Natural Language Processing (EMNLP), pages 9347-9359, Online. Association for Computational Linguistics.), and evaluates summaries based on two metrics:
Conciseness: Avoiding unnecessary details. Interpreted as precision of Key Facts.
Completeness: Encompassing the majority of key facts in the summary. Interpreted as Re-call of Key Facts.

### Configurations

GraphRAG is designed to use Microsoft Supported LLMs and Embedding (OpenAI Models). In the experiments, Ollama's Mistral-7B LLM and Nomic-Embed-Text embedding model were employed due to limited access to models. Consistent settings were applied across all experiments: chunk size (1200), overlap (100), and summary length (1000). ChromaDB is used as vector store in NaiveRAG. For domain-adaptation, taking advantage of Llama3.1-405B's larger context window and expanded parameter set, it was used for generating various prompts and LLM as an optimizer, as depicted in FIG. 2. System performance was evaluated by a Judge LLM, Cohere Command R+, which is a separate LLM from the generator and optimizer LLM.

### F) Results

The results (Table 2) revealed that the Naive RAG approach surpasses the GraphRAG on FNS. Table 3 contains examples of summaries. The key takeaways from the analysis are summarized below.
Comprehensiveness: Naive RAG provides more comprehensive summaries, capturing key aspects of the financial reports, including financial highlights, performance, strategy, and market trends. In contrast Graph RAG focuses on broader themes such as role of employees and the management development program but omitting detailed financial and strategic insights which may limit its usefulness for user seeking detailed financial information.
Directness: Naive RAG exhibits a higher degree of directness, maintaining a tight alignment with the source material and concentrating on key financial metrics, financial performance, strategic initiatives, and outlook. In contrast, Graph RAG tends to deviate from the main theme, emphasizing peripheral aspects such as employee contributions, community dynamics, and external events, rather than providing a straightforward account of financial performance and strategic initiatives, due to its prioritization of entity relationships that can introduce tangential information.
Completeness: The Naive RAG approach achieves a high degree of completeness, successfully extracting key financial metrics, strategic information, and important business details from the input text. In contrast, the Graph RAG approach falls short, frequently omitting crucial metrics and details that are present in the reference summaries. This disparity in performance is attributed to the limitations of the graph-based approach, specifically its structure and entity list, which hinder its capacity to thoroughly retrieve relevant information, ultimately leading to less comprehensive summaries.
Conciseness: The evaluation revealed that Naive RAG generates concise summaries, effectively balancing brevity and informativeness by focusing on key financial figures and insights without unnecessary elaborations. In contrast, Graph RAG sometimes includes irrelevant or overly abstract information, reducing its precision and conciseness. Specifically, it occasionally introduces extraneous concepts and details not directly related to the main topic of the financial report, detracting from the summary's focus.

TABLE 2
Comparison of NaiveRAG vs GraphRAG on Validation Dataset

| | Comprehen- | Direct- | Complete- | Concise- |
|---|---|---|---|---|
| Approach | siveness | ness | ness | ness |
| Default GraphRAG | 57.66 | 67.48 | 5.99 | 18.57 |
| Naive RAG | 79.81 | 79.79 | 27.18 | 49.53 |

TABLE 3
GraphRAG Domain Adaptation Results: Comparison
of GraphRAG's Domain Adaptation vs. Our Optimized
Domain Adaptation on Validation Dataset

| | Comprehen- | Direct- | Complete- | Concise- |
|---|---|---|---|---|
| Approach | siveness | ness | ness | ness |
| Default GraphRAG | 57.66 | 67.48 | 5.99 | 18.57 |
| GraphRAG's Domain | 67.81 | 79.69 | 10.43 | 26.06 |
| Adaptation | | | | |
| Optimized Domain | 75.45 | 83.17 | 10.04 | 24 |
| Adaptation | | | | |

The optimized domain adaptation approach described herein enhanced Graph RAG's ability to generate more accurate and detailed summaries by embedding enriched entity relationships as context. As shown in (Tables 6 and 7), summaries contain relevant entities like revenue, net income, and operating expenses, resulting in a more comprehensive summary. The broader entity list improved coverage of key financial and operational concepts, while entity relationships provided deeper insights into interconnected financial details. The expanded graph structure included both strategic and granular financial metrics. The results (Table 3) demonstrated improvements in comprehensiveness and directness, reflecting the better capture of relevant entities.

Despite the optimization, Naive RAG still outperforms GraphRAG (Tables 2 and 3). The Naive RAG technique achieves a highly relevant summary by directly integrating information from the source document, effectively capturing key financial metrics and contextual elements. Unlike GraphRAG, Naive RAG successfully identifies critical aspects such as acquisition targets, executive leadership changes, and the impact of external factors like Brexit. This direct integration results in summaries that align closely with ground-truth references.

In contrast, while entity recognition is improved, GraphRAG's ability to extract all relevant entities and establish detailed relationships remained limited. This constraint hampers its capacity to construct a comprehensive knowledge graph. By prioritizing relational and community-level summarization, GraphRAG often sacrifices critical details, leading to summaries that are high-level and less informative. For example, it mentions growth trends without providing comparative figures and references acquisitions without specifying details. Furthermore, it omits external contextual factors, such as Brexit, which are essential for a nuanced analysis.

The following tables include example summaries for exemplary use cases—Vodafone Group PLC and Volution Group PLC, generated using two different methods: Naive RAG vs GraphRAG (Tables 4 and 5), as well as Auto Tuning vs the optimized Auto Tuning approach described herein (Tables 6 and 7).

TABLE 4
Comparison of Summaries Generated by NaiveRAG vs Default GraphRAG for Vodafone Group PLC.

| Naive RAG | Default GraphRAG |
|---|---|
| Vodafone Group Plc, in its Annual Report for the | Vodafone Group Plc, a key player within the Europe |
| year 2022, highlights its commitment to enabling an | TV Subscribers community, has shown a significant |
| inclusive and sustainable digital society while | financial standing with a total revenue of €46,123 |
| ensuring responsible business practices. The report | million in the year under review [Data: Reports (1)]. |
| covers strategic, operational, and financial | This substantial income suggests a strong position |
| progress. | within this market. |
| In terms of financial performance, the Group's rev- | The report also reveals that Vodafone Group Plc's |
| enue stood at £45,580 million in 2022, represent- | net profit for the year was €4,286 million, indi- |
| ing a growth from £43,809 million in 2021 and a | cating a profitable operation within the Europe TV |
| slight decrease from £44,974 million in 2020. The | Subscribers community [Data: Reports (1)]. This |
| Group's service revenue amounted to £38,203 mil- | profitability underscores the company's ability to |
| lion in 2022, up from £37,141 million in 2021 but | generate earnings and reinvest in its services. |
| slightly lower than the £37,871 million recorded in | At the end of the year under review, Vodafone |
| 2020. | Group Plc's total assets were €84,672 million, high- |
| Employee engagement was another area of focus | lighting its substantial financial resources within |
| for Vodafone. The average number of employees | this community [Data: Reports (1)]. This asset |
| and contractors remained relatively stable at 104 | base provides a strong foundation for future growth |
| thousand in both 2021 and 2022, compared to 103 | and expansion. |
| thousand in 2020. Employee engagement index | While the annual financial report does not provide |
| also saw a slight increase from 73% in 2021 to 74% | specific information about Vodafone Group Plc's |
| in 2022. | subscriber base within the Europe TV Subscribers |
| Vodafone prides itself on its responsible business | community, it is known that this community has a |
| practices and operating lawfully with integrity. The | large number of subscribers [Data: Entities]. This |
| company's progress towards its purpose is reflected | suggests potential opportunities for growth and ex- |
| in these key performance indicators. | pansion for Vodafone Group Plc within this market. |
| The Annual Report also includes references to the | In conclusion, Vodafone Group Plc's annual financial |
| Group's website for additional information, such as | report presents a positive outlook for the company |
| videos, ESG Addendum, and TCFD report. Readers | within the Europe TV Subscribers community. |
| are advised that online content is for convenience | With its strong financial standing, profitable opera- |
| only and does not form part of this annual report. | tion, substantial resources, and potential for growth, |
| The document provided is the UK version of the | Vodafone Group Plc is well-positioned to capitalize |
| Annual Report, with the US Securities and Exchange | on opportunities in this market. |
| Commission (SEC) filing to follow at a later date. | |
| Some of the highlights from Vodafone's FY22 include: | |
| Strong focus on digital society and responsible | |
| business practices - Financial progress: Group rev- | |
| enue increased from £43.8 billion in 2021 to £45.6 | |
| billion in 2022, with a slight decrease in service | |
| revenue from £37.9 billion in 2020 to £38.2 billion | |
| in 2022 - Employee engagement index rose slightly | |
| from 73% in 2021 to 74% in 2022 - Commitment | |
| to sustainability and ethical business practices | |
| The Annual Report emphasizes that the company's | |
| success is measured through its key performance | |
| indicators, which reflect both financial and non- | |
| financial aspects of its business. These indicators | |
| help underpin the delivery of Vodafone's purpose | |
| and ensure sustainable, long-term growth. | |

TABLE 5
Comparision of Sumamries Genertated by NaiveRAG
vs Default GraphRAG for Volution Group PLC.

| Naive RAG | Default GraphRAG |
|---|---|
| Volution Group plc, in its Annual Report for the | Volution Group PLC, a company that has integrated |
| year ended Jul. 31, 2017, reported strong financial | two new businesses, attributes its success to the sig- |
| results despite the uncertainties brought about by | nificant contributions made by its employees [Data: |
| the UK's vote to leave the European Union and the | Reports (0)]. The central entity within the Ver- |
| devaluation of Sterling against major currencies. | dant Oasis Plaza community, Volution Group PLC, |
| The company's strategy revolves around building a | values its Management Development Programme |
| more valuable Volution Group through brand port- | which plays a pivotal role in the integration of new |
| folio expansion and market and geographical diver- | acquisitions and the formation of the overall Group |
| sification. | culture [Data: Reports (0)]. |
| The financial highlights revealed a 19.8% increase | The employees of Volution Group PLC are not only |
| in revenue, with figures reaching £185.1 million in | integral to its success but also significantly con- |
| 2017 compared to £154.5 million in 2016. Ad- | tribute to the organization's performance [Data: Re- |
| justed operating profit grew by 9.6% to £35.6 mil- | ports (0)]. The dynamics of the Verdant Oasis Plaza |
| lion (19.3% of revenue), and there was a significant | community are crucial in understanding the rela- |
| increase in adjusted EPS, with basic EPS standing | tionship between the plaza and any events that may |
| at 35.9p and diluted EPS at 32.5p. The net debt | take place there, such as the Unity March, which |
| stood at £37.0 million, an increase from the previ- | could potentially pose a threat [Data: Reports (0)]. |
| ous year's £21.2 million. Reported profit before tax | Currently, Verdant Oasis Plaza is experiencing me- |
| was £17.9 m with a loss of (4.2)p per share. | dia attention due to the Unity March taking place |
| Volution Group reported strong cash generation and | within the plaza. This increased exposure could |
| continued revenue and underlying operating profit | amplify its impact on the community [Data: Re- |
| growth for the sixth consecutive year. The com- | ports (0)]. It's essential to consider the nature of |
| pany also uses alternative performance measures to | the Unity March and the reactions it provokes when |
| assess the business's underlying performance, | analyzing the relationship between the march and |
| including adjusted operating profit, adjusted profit | the plaza. |
| before tax, adjusted basic and diluted EPS, and | In conclusion, Volution Group PLC's success is |
| adjusted operating cash flow. | largely due to the contributions made by its employ- |
| Chairman Peter Hill expressed his satisfaction with | ees, and its Management Development Programme |
| the progress made during the year and the com- | plays a crucial role in integrating new acquisitions |
| pany's confidence in its long-term prospects despite | and shaping the overall Group culture. The dynamics |
| Brexit uncertainties. The Group continued to make | of the Verdant Oasis Plaza community are significant |
| strategic moves by making selective value-adding | when understanding events that take place |
| acquisitions and expansions, all while focusing on | within the plaza, such as the Unity March. The in- |
| growth opportunities in both established and emerg- | creased media attention on the Unity March could |
| ing markets. | potentially impact the community. For more de- |
| In conclusion, Volution Group plc reported a suc- | tailed information, please refer to the relevant data |
| cessful financial year with revenue and underlying | records (0, +more) |
| operating profit growth, significant cash generation, | |
| and strong strategic progress, despite the economic | |
| uncertainties brought about by Brexit. The company | |
| remains committed to its strategy of building | |
| a more valuable Volution Group through brand | |
| portfolio expansion and market and geographical | |
| diversification. | |

TABLE 6
Comparison of Summaries Generated by GraphRAG's Domain Adaptation
vs. Our Optimized Domain Adaptation for Vodafone Group PLC.

| GraphRAG's Domain Adaptation | Optimized Domain Adaptation |
|---|---|
| Vodafone Group Plc, a leading telecommunications | Vodafone Group Plc, a significant player in the IoT |
| company, reported a total revenue of £46.2 billion | sector, reported approximately 150.1 million IoT |
| for the fiscal year [Data: Reports (1)]. This sig- | SIM connections [Data: IOT SIM CONNECTIONS |
| nificant financial performance indicates a strong | MILLION (top 5 relevant record ids)], indicating |
| position in the market. However, it is important to | a growing interest in IoT services and potential for |
| note that the company's net debt stood at £38.7 | further expansion. This figure suggests that |
| billion, demonstrating a substantial debt level that | Vodafone is well-positioned to capitalize on the |
| could impact future financial decisions [Data: Re- | increasing demand for IoT solutions. |
| ports (2)]. | The total revenue generated by Vodafone Group Plc |
| The report highlighted a focus on cost optimization | stands at a substantial 24.7 billion Kenyan shillings |
| and network investments, aiming to improve prof- | [Data: REVENUE (top 5 relevant record ids)], indi- |
| itability and customer experience [Data: Reports | cating a strong financial performance and the ability |
| (4)]. Despite these efforts, Vodafone Group Plc ex- | to invest in future growth initiatives. This revenue |
| perienced a decline in EBITDA margin to 31.4%, | figure underscores the company's robust market po- |
| suggesting operational efficiency challenges [Data: | sition and its capacity to drive innovation. |
| Reports (3)]. | However, it is important to note that while Vodafone |
| On a positive note, Vodafone Group Plc's free cash | Group Plc is profitable, there is room for improve- |
| flow improved to £7.2 billion, signaling a positive | ment in managing costs. The current net income |
| cash position for the company [Data: Reports (5)]. | stands at 6.8 billion Kenyan shillings, while op- |
| This improvement in cash flow could provide the | erating expenses amount to 17.9 billion Kenyan |
| necessary resources for the company to address its | shillings [Data: NET INCOME (top 5 relevant |
| debt and operational efficiency issues. | record ids), OPERATING EXPENSES (top 5 rel- |
| In conclusion, while Vodafone Group Plc demon- | evant record ids)]. This implies that the company |
| strated a strong financial performance with a sig- | could optimize its operations to increase |
| nificant revenue of £46.2 billion, it also faces chal- | profitability. |
| lenges in terms of operational efficiency and a sub- | The IoT Service Provider Community report, while |
| stantial debt level. The company's focus on cost | not explicitly naming Vodafone Group Plc, sug- |
| optimization and network investments, as well as | gests that the company's IoT operations are part of |
| the improvement in free cash flow, could potentially | a broader context [Data: Reports (other than IOT |
| help address these issues. Further analysis of addi- | SIM CONNECTIONS MILLION, REVENUE, |
| tional reports [Data: Reports (+more)] may provide | NET INCOME, OPERATING EXPENSES)]. This |
| more insights into the company's future financial | report provides insights into the performance and |
| decisions and performance. | growth trends within the IoT service provider com- |
| | munity, which could be beneficial for Vodafone in |
| | strategizing its future moves. |
| | Regarding ownership structure and allegations of |
| | wrongdoing, these details are not explicitly pro- |
| | vided in the IoT Service Provider Community re- |
| | port [Data: Reports (other than IOT SIM CONNEC- |
| | TIONS MILLION, REVENUE, NET INCOME, |
| | OPERATING EXPENSES)]. For such information, |
| | it is recommended to consult other relevant reports |
| | [Data: Reports (2, 7, 34, 46, 64, +more)]. |

TABLE 7
Comparison of Summaries Generated by GraphRAG's Domain Adaptation
vs. Our Optimized Domain Adaptation for Volution Group PLC.

| GraphRAG's Domain Adaptation | Optimized Domain Adaptation |
|---|---|
| Volution Group PLC, a company that has integrated | Volution Group plc, a leading international venti- |
| two new businesses, attributes its success to the sig- | lation technology group, has announced its annual |
| nificant contributions made by its employees [Data: | financial results for the year ended Dec. 31, 2021. |
| Reports (0)]. The central entity within the Ver- | The report highlights a strong performance |
| dant Oasis Plaza community, Volution Group PLC, | across various key areas, demonstrating resilience |
| values its Management Development Programme | and growth despite the challenging global economic |
| which plays a pivotal role in the integration of new | climate. |
| acquisitions and the formation of the overall Group | Revenue for the year increased by 14.6% to £257.8 |
| culture [Data: Reports (0)]. | million (2020: £223.9 million), driven primarily |
| The employees of Volution Group PLC are not only | by organic growth and strategic acquisitions. The |
| integral to its success but also significantly con- | Group's operating profit rose significantly, up |
| tribute to the organization's performance [Data: | 37.6% to £50.2 million (2020: £36.6 million). |
| Reports (0)]. The dynamics of the Verdant Oasis Plaza | This improvement was underpinned by a focus on |
| community are crucial in understanding the rela- | operational efficiency, cost management, and the |
| tionship between the plaza and any events that may | successful integration of acquired businesses. |
| take place there, such as the Unity March, which | The Group's adjusted earnings before interest, taxes, |
| could potentially pose a threat [Data: Reports (0)]. | depreciation, and amortization (EBITDA) increased |
| Currently, Verdant Oasis Plaza is experiencing media | by 27.4% to £59.8 million (2020: £46.3 million), |
| attention due to the Unity March taking place | reflecting improved profitability across the business. |
| within the plaza. This increased exposure could | The reported profit before tax was £41.2 million, |
| amplify its impact on the community [Data: Reports | compared to £28.8 million in 2020, representing a |
| (0)]. It's essential to consider the nature of | growth of 43.7%. |
| the Unity March and the reactions it provokes when | The Group's net cash position at year-end stood at |
| analyzing the relationship between the march and | £56.9 million (2020: £34.4 million), demonstrat- |
| the plaza. | ing strong cash generation and financial discipline. |
| In conclusion, Volution Group PLC's success is | This robust cash position will support the Group's |
| largely due to the contributions made by its employ- | ongoing investment in innovation, strategic acquisi- |
| ees, and its Management Development Programme | tions, and organic growth opportunities. |
| plays a crucial role in integrating new acquisitions | The Board proposes a final dividend of 17.5 pence |
| and shaping the overall Group culture. The dynamics | per share (2020: 13.0 pence), bringing the total |
| of the Verdant Oasis Plaza community are sig- | dividend for the year to 24.0 pence per share, an |
| nificant when understanding events that take place | increase of 89.3% compared to the previous year. |
| within the plaza, such as the Unity March. The in- | This reflects the Group's strong financial perfor- |
| creased media attention on the Unity March could | mance and commitment to returning value to share- |
| potentially impact the community. For more detailed | holders. |
| information, please refer to the relevant data | Looking ahead, Volution Group remains confident |
| records (0, +more). | in its strategic direction and market opportunities. |
| | The Group will continue to focus on innovation, |
| | operational efficiency, and strategic acquisitions to |
| | drive growth and create long-term shareholder |
| | value. The management team is excited about the |
| | prospects for the future and looks forward to nav- |
| | igating the challenges and opportunities that lie |
| | ahead. |

### Overview of an AI-Enabled Summarization System

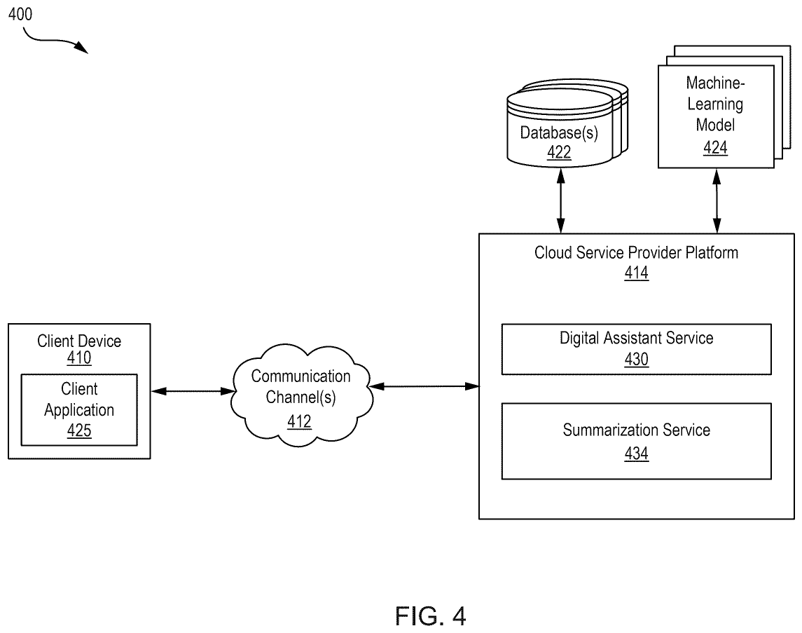

FIG. 4 is an example of an AI-enabled system 400 that includes capabilities for providing various services to users. The end-users may utilize the various services provided by the cloud service provider platform 414 to perform various functions. The AI-enabled system 400 includes one or more client devices 410 (hereinafter “client devices 410”), one or more communication channels 412 (hereinafter “communication channels 412”), a cloud service provider platform 414 (hereinafter “platform 414”), one or more databases 422 (hereinafter “databases 422”), and one or more machine learning models 424 (hereinafter “models 424”). While FIG. 4 shows the databases 422 and the models 424 in one particular configuration, this is not intended to be limiting, and one or more of the databases 422 and/or one or more of the models 424 can be included separately or as part of the platform 414 and/or the cloud infrastructure in which the platform 414 is included.

The AI-enabled system 400 provides intelligent assistant services to users. The users interact with system 400 using client devices 410. Each client device included in the client devices 410 can be any kind of electronic device that is capable of: executing applications; presenting information textually, graphically, and audibly such as via a display and a speaker; collecting information via one or more sensing elements such as image sensors, microphones, tactile sensors, touchscreen displays, and the like; connecting to a communication channel such as the communication channels 412 or a network such as a wireless network, wired network, a public network, a private network, and the like, to send and receive data and information; and/or storing data and information locally in one or more storage mediums of the electronic device and/or in one or more locations that are remote from the electronic device such as a cloud-based storage system, the platform 414, and/or the databases 422. Large organizations or enterprises may have thousands, tens of thousands, or hundreds of thousands—or even more—client devices being used simultaneously for conducting business in various capacities. Examples of electronic devices include, but are not limited to, mobile phones, desktop computers, portable computing devices, computers, workstations, laptop computers, tablet computers, and the like.

In some implementations, application 425 can be installed on, executing on, and/or accessed by a client device included in the client devices 410. The application 425 and/or a user interface of the application can be utilized and/or interacted with (e.g., by an end user) to access, utilize, and/or interact with one or more services provided by the platform 414. An example of an application that be installed on, executed on, and/or accessed by client devices 410 is am Oracle Fusion Application. The client device 410 can be configured to receive multiple forms of input such as touch, text, voice, images, and the like, and the application 425 can be configured to transform that input into one or more messages which can be transmitted or streamed to the platform 414 using one or more communication channels of the communication channels 412. Additionally, the client device 410 can be configured to receive messages, data, and information from the platform 414 using one or more communication channels of the communication channels 412 and the application 425 can be configured to present and/or render the received messages, data, and information in one or more user interfaces of the application 425.

Each communication channel included in the communication channels 412 can be any kind of communication channel that is capable of facilitating communication and the transfer of data and/or information between one or more entities such as the client devices 410, the platform 414, the databases 422, and the models 424. Examples of communication channels include, but are not limited to, public networks, private networks, the Internet, wireless networks, wired networks, fiber optic networks, local area networks, wide area networks, and the like. The communication channels 412 can be configured to facilitate data and/or information streaming between and among the one or more entities. In some implementations, data and/or information can be streamed using one or more messages and according to one or more protocols. Each of the one or more messages can be a variable length message and each communication channel included in the communication channels 412 can include a stream orchestration layer that can receive the variable length message in accordance with a predefined interface, such as an interface defined using an interface description language like AsyncAPI. Each of the variable length messages can include context information that can be used to determine the route or routes for the variable length message as well as a text or binary payload of arbitrary length. Each of the routes can be configured using a polyglot stream orchestration language that is agnostic to the details of the underlying implementation of the routing tasks and destinations.

Each database included in the databases 422 can be any kind of database capable of storing data and/or information and managing data and/or information. Data and/or information stored by each database 422 can include data and/or information generated by, provided by, and/or otherwise obtained by the platform 414. Additionally, or alternatively, data and/or information stored and/or managed by each database 422 can include data and/or information generated by, provided by, and/or otherwise obtained by other sources such as the client devices 410 and/or models 424. In some cases, the cloud service provider platform 414 and the databases 422 may be configured to securely store or transmit electronic information that is protected. Examples of protected information can include health information, financial information, personal information, or other types of protected information. Examples of secure storage or transmission of electronic information can include encryption, hashing, randomization, access authentication, or other techniques to secure electronic information.

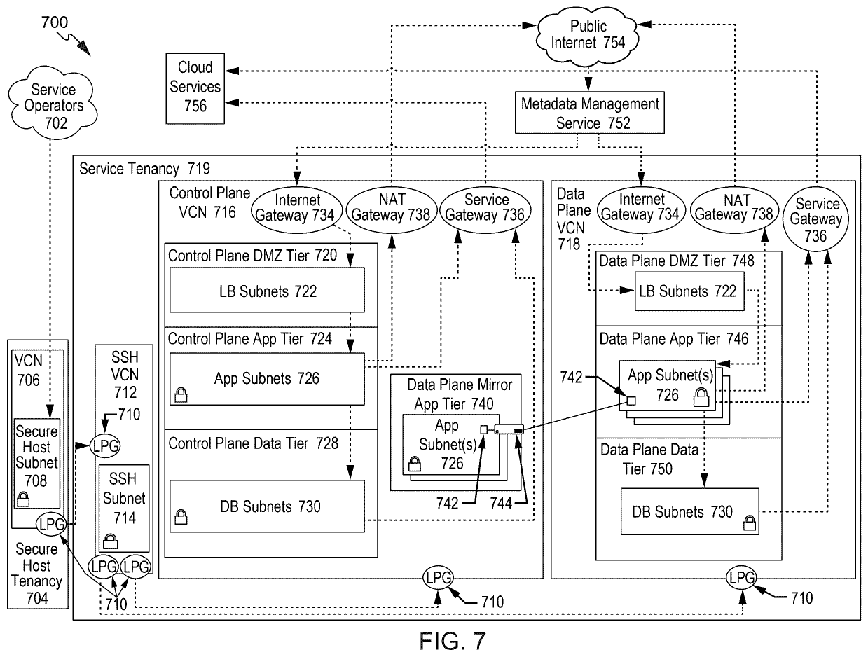

One or more databases that are included in the databases 422 can be part of a platform for storing and managing information such as electronic records for customers, electronic records of healthcare or financial services providers, and the like, and can store and manage electronic records for customers of healthcare or financial services providers. Each electronic record associated with a customer can be linked to other electronic records associated with additional information. In some instances, the databases 422 store electronic records as one or more data entities, such as database records, digital files, or other types of data objects. For example, the databases 422 store a particular electronic record as one or more data entities that describe information for a customer associated with the particular electronic record, such as data entities that respectively describe personal information, financial reports, medical reports, business reports, or other types of digitally stored information. In some embodiments, the databases 422 include one or more electronic records or reports that are digitally secured data entities, such as financial reports that include protected information for associated customers. Additionally, one or more databases included in the databases 422 can be provided by, managed by, and/or otherwise included as part of a cloud infrastructure of a cloud service provider (e.g., Oracle Cloud Infrastructure or OCI, see, e.g., description of FIGS. 7-11). Data and/or information stored and/or managed by the databases 422 can be accessed using one or more application programming interfaces (APIs) of the databases 422.

The one or more machine learning models 424 can include but are not limited to: pre-trained machine-learning models, opensource machine-learning models, licensed machine-learning models, generative machine-learning models, transformer-based machine-learning models, and the like. The models 424 can be any kind of machine-learning model that can facilitate the providing of various services by the cloud service provider platform 414. More specifically, the one or more machine learning models 424 can include large language model (LLM), multimodal LLMs, automatic speech recognition (ASR) model, and the like. For example, in some cases, the platform 414 may generate text (e.g., summarizations) from input data. As such, the platform 414 could utilize a service in which one of the models in the one or more models 424 is a LLM used to generate the text (e.g., a summary of financial report). In another example, the platform 414 may use a LLM or a multimodal LLM capable of obtaining, generating, and/or retrieving one or more results in response to one or more inputs such as one or more prompts. Prompts for obtaining or generating or retrieving results from the LLM or multimodal LLM (e.g., the prompts and optimized prompts discussed with respect to FIG. 2) can be obtained from or generated by or retrieved from or accessed from the client devices 410, the databases 422, the platform 414, and/or one or more other sources such as the Internet. Each prompt can be configured to cause the LLM or multimodal LLM to perform one or more tasks (e.g., a summarization task), which causes one or more results to be provided or generated and the like.

The platform 414, for example an Oracle Fusion Application Platform, can be included as part of a cloud infrastructure of a cloud service provider (e.g., Oracle Cloud Infrastructure or OCI, as described in detail with respect to FIGS. 7-11). The platform 414 can be configured to communicate with, send data and information to, and receive data and information from the client devices 410 via the communication channels 412. Additionally, the platform 414 can be configured to interact with the databases 422 and the models 424 to obtain and/or receive data and information from the databases 422 and the models 424. Data and information received from the client devices 410, the databases 422, and the models 424 can be used by the platform 414 to execute tasks and perform services, such as cloud services, to subscribers (e.g., end-users) of the cloud service provider platform 414.

In the AI-enabled system 400, the cloud service provider platform 414 provides one or more services, including the cloud services, to additional computing systems included in (or in communication with) the AI-enabled system 400. For example, the cloud service provider platform 414 can provide one or more digital services to the client devices 410. The platform 414 can be configured to include various capabilities and provide various services to subscribers (e.g., end users) of the various services. In some implementations, in the case of an end user or subscriber being a financial analyst, the financial analyst can utilize the various services to facilitate the analysis, management, and use of various financial data and information. The services provided by the cloud service provider platform 414 may include, but are not limited to, a digital assistant service 430 and a summarization service 434. For example, a financial analyst can utilize the functionality of a digital assistant as part of a service provided by the platform 414 to summarize and analyze financial data. The services may further include authentication services, user management services, frontend services (e.g., a single-entry point to all services), and other management services. The various services may be implemented on one or more servers of the cloud service provider platform 414 using the one or more machine-learning models 424. Additionally, the various services may be provided to end-users who subscribe to the services provided by the platform 414. In a certain implementation, the services provided by the cloud service provider platform 414 may be implemented as machine-learning-based or artificial intelligence (AI)-based digital assistance tools (e.g., agentic AI-based assistants) that may be provided to end-users. For instance, the cloud service provider platform 414 can provide one or more digital assistance tools that utilize the one or more machine-learning models 424.

The digital assistant service 430 can be configured to serve as an artificial intelligence-driven (AI-driven) conversational-type interface for the platform 414 that can conduct conversations with end users (e.g., those using the client devices 410) and perform functions and/or tasks based on the information conveyed by and/or ascertained from those conversations and other sources. The digital assistant service 430 can be configured with and/or configured to access natural language understanding (NLU) capabilities such as natural language processing, named entity recognition, intent classification, and so on. In some implementations, the example conversational-type interface service can be skill-driven in which the example service includes bots that each include one or more skills for conducting conversations and performing functions and/or tasks. In some implementations, the example conversational-type interface service can be LLM-based and agent-driven in which agent(s) coordinate with LLM(s) for conducting conversations and performing functions and/or tasks. Examples of skill-driven and LLM-based and agent-driven digital assistants are described in U.S. patent application Ser. No. 17,648,376, filed on Jan. 19, 2022, and U.S. patent application Ser. No. 18/624,472, filed on Apr. 2, 2024, each of which are incorporated by reference as if fully set forth herein. Additionally, the models 424 can include or have any size context window (i.e., can accept any number of tokens) and can be capable of interpreting complex instructions. The models 424 can be provided by, managed by, and/or otherwise included as part of the platform 414 and/or a cloud infrastructure of a cloud service provider (e.g., Oracle Cloud Infrastructure or OCI) that supports the platform 414.

In a healthcare or financial setting in which the AI-enabled system 400 could be used, the digital assistant services 430 could participate in dialogs, such as dialog or conversation of a healthcare provider or financial analyst, with one or more digital assistance tools (e.g., a diagnosis digital assistance tool, a recordkeeping digital assistance tool, a financial analysis tool, etc.) In some cases, dialog in the example healthcare or financial setting involves information relevant to one or more electronic health records or financial reports, such as information regarding the care, treatment, observation, diagnoses for one or more patients or information regarding the financial position of one or more customers or an enterprise. In some instances, the tools provided by the digital assistant services 430 can participate in dialogs in the example healthcare or financial setting. For example, a user such as an financial analyst could use an AI-based tool to automatically summarize one or more financial reports. In yet another example, an AI-based tool could automatically generate a health summary report for each patient having an appointment with a healthcare practitioner on a particular day, to allow the healthcare practitioner to quickly review medical information for each patient scheduled that day.

The summarization service 434 can be configured to automatically generate a structured, summary report from various modal inputs (e.g., audio, text, or images). To generate a summary report, the summarization service 434 can be configured to access input such as text (e.g., a financial report) and generate a summary report from the text. The text can be a text obtained or generated by the user and/or a text stored in and/or accessed from the platform 414, the databases 422, the models 424, and/or another location such as the client devices 410. For example, the text can be stored in a database or storage medium in association with a first entity, a second entity, and/or other entities. For example, the text can be stored in a database of the databases 422 in association with an electronic record or electronic records of the healthcare provider and/or an electronic health record or electronic health records of a patient of the healthcare provider. In some implementations, a summary report can be generated automatically in response to a particular trigger or indication. For example, an end user of the client devices 410 can provide an indication to the client devices 410 that a summary report is desired (e.g., a voice or GUI input command). The client devices 410 can provide a message describing that indication to the platform 414 and/or the digital assistant services 430, and the platform 414 and/or digital assistant services 430 can call one or more services of the platform 414 (e.g., the summarization service 434) to begin a process for generating a summary report. In another example, a conversation in which the digital assistant service 430 is a participant can learn that an end user intends for a summary report to be generated and can call the summarization service 434 to begin a process for a generating a summary report. In another example, a button in a graphical user interface displayed on the client devices 410 can be activated and cause the platform 414 and/or a service of the platform 414 to begin a process for generating a summary report. In some implementations, a summary report can be generated automatically at particular intervals (e.g., once per day, every time an interaction between entities concludes, and the like).

The summarization service 434 can generate a summary report from the input such as the text using the models 424. To generate the summary report from the input using the models 424, the summarization service 434 can access one or more prompts (e.g., one or more prompts stored in the platform 414, the databases 422, and/or in another location and generated and/or optimized as described with respect to FIG. 2)), and provide the one or more prompts to the models 124 to obtain one or more results (hereinafter “results”). Each prompt of the one or more prompts can include a request for or a query for or a task to be performed by the models 424 and contextual information (see examples and discussion herein concerning original and optimized versions of the various prompts including the entity and relationship extraction prompt, entity type generation prompt, entity relationship example generation prompt, and entity and relationship extraction prompt). The contextual information can include the input such as the text or portions or segments of the input such as a chunk of the text, information about an entity of the interaction (e.g., information about the healthcare provider, information about the user or customer such as information included in an electronic health record for a patient, information about an author or source of a financial report, and the like), and/or other information or records (e.g., laboratory health records, market trends, supporting documents for financial records or reports, and the like). The results can include the summary report and/or portions or sections of the summary report that are combined or assembled into the summary report (e.g., by models 424 or other processing). In some implementations, the results can be processed to refine the results. For example, the one or more prompts can include a prompt which when provided to the models 424 causes the models 424 to process the summary report to refine and/or improve the summary report in the case the results include the summary report and/or process the portions or sections of the summary report to refine and/or improve the portions or sections in case the results include the portions or sections of the summary report.

Summary reports generated by the summarization service 434 can be stored within the platform 414 and/or in another location such as in one or more databases of the databases 422, where they can be accessed by the platform 414, one or more other services of the platform 414 such as the digital assistant service 430, and/or the models 424. Additionally, or alternatively, summary reports generated by the summarization service 434 can be provided to one or more other services of the platform 414 such as the digital assistant service 430 and/or the models 424. For example, the summarization service 434 can generate a summary report and provide the summary report to the digital assistant service 430 where it can be used in a conversation the digital assistant service 430 is participating in. Summary reports generated by the summarization service 434 can be stored in a database or storage medium in association with one or more entities of the interaction. For example, a summary report documenting an interaction involving a financial analysts and a customer or a summary report for a given financial report can be stored in a database of the databases 422 in association with or within an electronic record such as the financial report or electronic records of the customer and/or an electronic health record or electronic health records of the patient, where it can be accessed by various users of the system.

Although not shown, the platform 414 can include other capabilities and services such as authentication services, management services, task management services, notification services, and the like. The various capabilities and services of the platform 414 can be implemented utilizing one or more computing resources and/or servers of the platform 414 and provided by the platform 414 by way of subscriptions. Additionally, or alternatively, while FIG. 4 shows the services of the platform 414 as being separate services, one or more of the services can be combined with other services and/or be considered to be a sub-service of another service. In some cases, the digital assistant service 430 and the summarization service 434 are accessed via one or more client applications 425 on the client devices 410 in the AI-enabled system 400. Each of the client applications 425 is configured to access one or more services provided by the cloud service provider platform 414.

The AI-enabled system 400 depicted in FIG. 4 is merely an example and is not intended to unduly limit the scope of claimed embodiments. One of ordinary skill in the art would recognize many possible variations, alternatives, and modifications. For example, in some implementations, the AI-enabled system 400 can be implemented using more or different services than those shown in FIG. 4, may combine two or more services, or may have a different configuration or arrangement of services.

### Summary Generation Systems

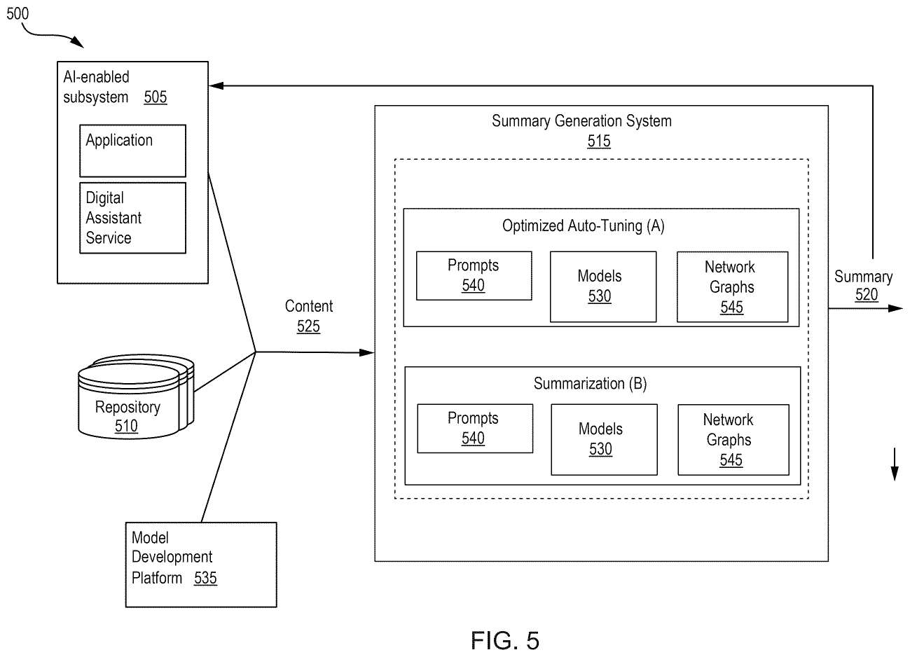

FIG. 5 depicts a computing environment 500 configured for summarizing inputs such as financial reports into a concise synthesis of key information and insights extracted from the inputs, tailored to a specific context, domain, and purpose (e.g., review of financial information for a customer). The summary generation system 505 may be implemented using software only, hardware only, firmware only, or any combination of hardware, software, and/or firmware. In some instances, the computing environment 500 is part of an Infrastructure as a Service (IaaS) cloud service (described in more detail with respect to FIGS. 7-11) and the systems and subsystems can be implemented as part of the IaaS by leveraging the scalable computing resources and storage capabilities provided by the IaaS provider to process and manage large volumes of data and complex computations. This setup can allow the summary generation system 505 to deliver real-time, responsive interactions while ensuring high availability, security, and performance scalability to meet varying demand levels. For example, the summary generation system 505 can be used to summarize inputs as part of the intelligent assistant services offered via IaaS to users (e.g., client application 425 and digital assistant service 430 from FIG. 4—part of an Oracle Fusion Application).

As depicted in FIG. 5, the computing environment 500 comprises subsystems, repositories, and models including but not limited to an AI-enabled subsystem 505 (e.g., at least a portion of the AI-enabled system 400 described with respect to FIG. 4), content repositories 510, and summary generation subsystem 515 (used to implement the summarization service 434). Each subsystem can be understood to include an execution of one or more processes and/or programs implemented with software, hardware, and/or firmware within a system (e.g., as described with respect to FIGS. 7-11). Moreover, it should be understood that the one or more processes and/or programs can be executed as part of an iterative process that ultimately generates a summary of content. Iteration or an iterative process being the process of repeating a set of instructions or steps multiple times or cycles. For example, a set of instructions or steps may be executed for generating one or more summaries and/or optimizing one or more prompts and repeatedly executing the set of instructions or steps multiple times or over multiple cycles results in the generation of multiple summaries and/or prompts (typically different summaries and prompts). Each cycle of the set of instructions or steps may be executed serially, or multiple cycles of the set of instructions or steps may be executed in parallel.

The summary generation subsystem 515 may be implemented using various configurations. In certain embodiments, the summary generation subsystem 515 may represent a computing system of an entity (for e.g., an organization, an enterprise, or an individual) that provides summary generation functionality to its users. In other embodiments, the summary generator subsystem 515 may be implemented on one or more servers or virtual machines of a cloud provider network and its summary generation services may be provided to subscribers of cloud services on a subscription basis. In other embodiments, the summary generator subsystem 515 may have some components implemented on a computing system and/or one or more servers or virtual machines of a cloud provider network and other components implemented on a separate computing system and/or separate one or more servers or virtual machines of a cloud provider network. The functionality for summary generation, as described in this disclosure, may be offered as part of the service (e.g., IaaS) via AI-enabled subsystem 505. For example, a user can subscribe to the service to generate a summary 520 of inputs (e.g., content 525) and the summary 520 can be provided to the user via AI-enabled subsystem 505. As part of generating the summary, in certain examples, the service may also render the summary 520 on a display of a computing device as part of a UI for the requesting user as described herein.

The computing environment 500 depicted in FIG. 5 is merely an example and is not intended to unduly limit the scope of claimed embodiments. One of ordinary skill in the art would recognize many possible variations, alternatives, and modifications. For example, in some implementations, the computing environment 500 can be implemented using more or fewer subsystems, repositories, and models than those shown in FIG. 5, may combine two or more subsystems, repositories, and models, or may have a different configuration or arrangement of subsystems, repositories, and models.

The summary generation system 515 is configured to (A) implement the optimized auto-tuning approach utilizing a generative model such as an LLM as an optimizer as described in detail with respect to FIG. 2 and (B) deploy and utilize optimized prompts and generative models from (A) to summarize inputs in a production environment. For instance, in one approach with respect to (A), the summary generation system 515 can be used to optimize entity and relation extraction using one or more models 530 (e.g., LLMs) and a model development platform 535. The model development platform 535 can be configured to train and/or fine tune models 530, engineer and optimize prompts 540, and test, validate, and evaluate models 530, and generate network graphs 545, as described in detail with respect to FIG. 2. The generated and/or optimized prompt(s) 540, models 530, and network graphs 545 may then be stored and/or deployed for use in a production environment. In another approach with respect to (B), the summary generation system 515 may receive, obtain, or be directed to (all of which are considered means of accessing the inputs) the content 525 via an application on a user device (e.g., application 425 described with respect to FIG. 4) and process the content 525 using the stored and/or deployed prompt(s) 540, models 530, and network graphs 545 from (A). In another approach with respect to (B), the summary generation system 515 may receive, obtain, or be directed to the content 525 from a digital assistant service (such as digital assistant service 430 described with respect to FIG. 4) and process the content 525 using the stored and/or deployed prompt(s) 540, models 530, and network graphs 545 from (A). In another approach with respect to (B), the summary generation system 515 may receive, obtain, or be directed to the content 525 from a different model or system (e.g., an automatic speech recognition computing system) and process the content 525 using the stored and/or deployed prompt(s) 540, models 530, and network graphs 545 from (A). In another approach with respect to (B), the summary generation system 515 may receive, obtain, or be directed to the content 525 from one or more repositories 510 (e.g., databases 422 described with respect to FIG. 4) and process the content 525 using the stored and/or deployed prompt(s) 540, models 530, and network graphs 545 from (A). A user may interact with the summary generation system 515 using a user device (e.g., client devices 410 described with respect to FIG. 4) that is communicatively coupled to the summary generation system 515, possibly via one or more communication networks. The user device may be of various types, including but not limited to, a mobile phone, a tablet, a desktop computer, and the like. The user may use an application to provide the inputs (e.g., content 525) to be summarized by the summary generation system 515. In another approach with respect to (B), the summary generation system 515 may receive, obtain, or be directed to the content 525 via a cloud service or a third-party system as described in further detail with respect to FIGS. 7-11) and process the content 525 using the stored and/or deployed prompt(s) 540, models 530, and network graphs 545 from (A).

In both (A) and (B), the summary generation system 515 utilizes one or more models 530 to generate prompts, network graphs, and summaries. The one or more models 530 comprise one or more machine learning models. In the specific context of this disclosure, the one or more machine learning models may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is important for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. GANs learn to generate new data that is indistinguishable from the data they were trained on, using a dual-network architecture that involves a generative component. VAEs are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Illustrative Approaches and Techniques

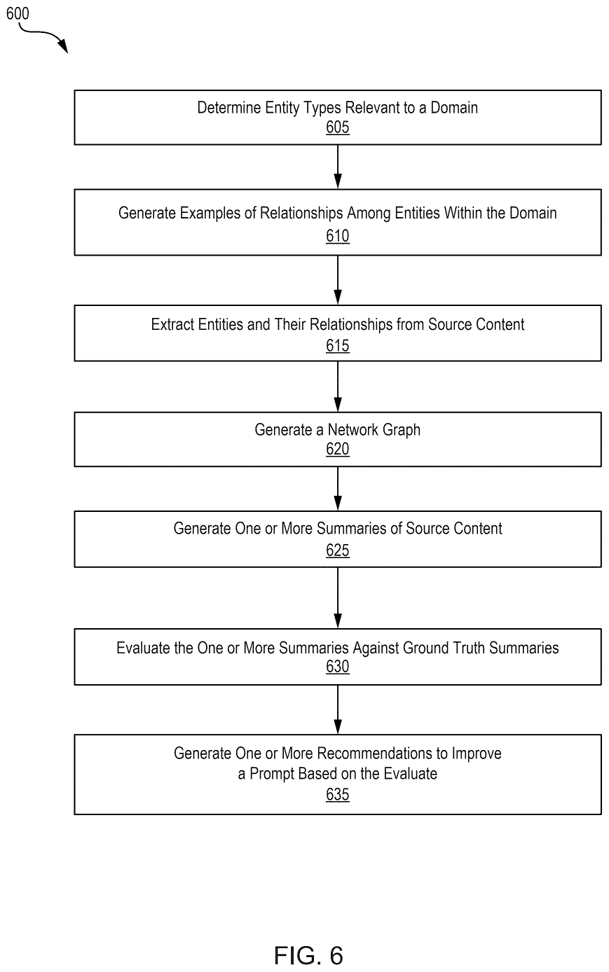

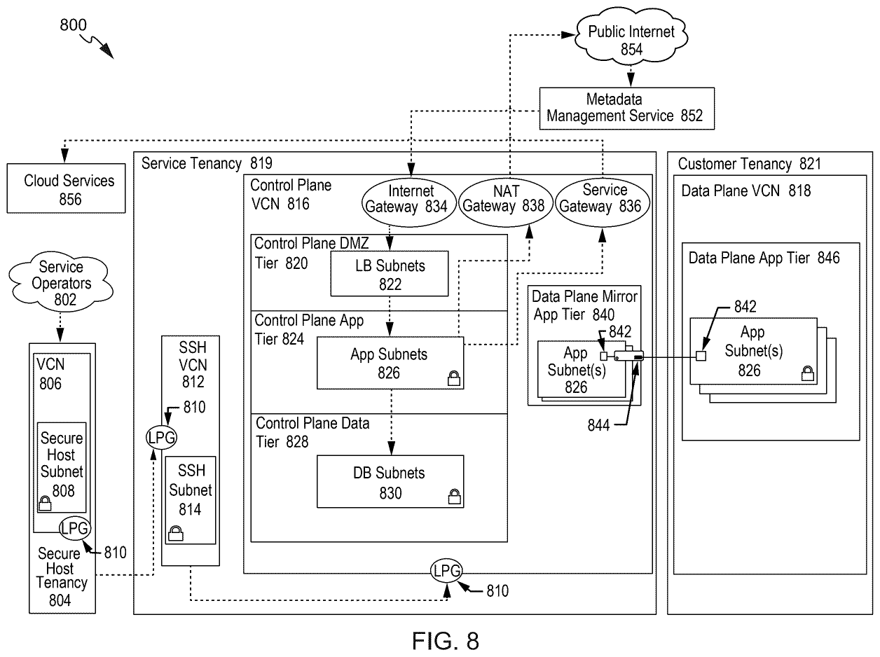

FIG. 6 is a flowchart illustrating a process 600 for optimized auto-tuning approach utilizing a generative model as an optimizer, according to various embodiments. The processing depicted in FIG. 6 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 8 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-7, the processing depicted in FIG. 6 may be performed by one or more of the components described with respect to the environments, workflows, and systems described therein. It should be understood, that although process 600 is described below specifically with respect to the task of document summarization, the steps and aspects of process 600 could be modified to implement any generative task without departing from the spirit and scope of the present disclosure.

At step 605, entity types relevant to a domain are determined by a generative model (e.g., a first generative model) based on an entity type generation prompt comprising the domain, a persona, and a sample of source content. In some instances, prior to determining the entity types, the domain and the persona for the sample of the source content is generated by a generative model (e.g., a sixth generative model) based on a domain and persona generation prompt comprising the sample of source content.

At step 610, examples of relationships among entities within the domain are generated by a generative model (e.g., a second generative model) based on an entity relationship example generation prompt comprising the entity types and the sample of the source content.

At step 615, entities and their relationships are extracted by a generative model (e.g., a third generative model) from the source content based on an entity and relationship extraction prompt comprising the entity types and the examples of relationships.

At step 620, a network graph is generated by a generative model (e.g., the third generative model) based on the extracted entities and their relationships.

At step 625, one or more summaries of the source content are generated by a fourth generative model based on the source content and the network graph.

At step 630, the generated one or more summaries are evaluated, by a fifth generative model and based on an optimizer prompt and objective function, against ground truth summaries. In some instances, the objective function is expressed as a set of instructions within the optimizer prompt. The set of instructions may cause the fifth generative model to compare the generated one or more summaries against ground truth summaries and analyze performance of the third generative model to extract the entities and their relationships from the source content based on the compare. The analyzing the performance of the third generative model may include identifying errors in extracting the entities and their relationships from the source content based on the compare and with attention to improving one or more metrics for measuring quality of the one or more summaries. The one or more metrics may include comprehensiveness, directness, completeness, conciseness, or any combination thereof. In some instances, the set of instructions further cause the fifth generative model to generate instructions, based on the analyzing and the one or more metrics, as the one or more recommendations to improve the entity type generation prompt, the entity relationship example generation prompt, the entity and relationship extraction prompt, or any combination thereof to align entities and their relationships with the specified objectives

At step 635, one or more recommendations are generated by the fifth generative model to improve the entity type generation prompt, the entity relationship example generation prompt, the entity and relationship extraction prompt, or any combination thereof to align entities and their relationships with specified objectives. For example, in some instances, the one or more recommendations are to improve the entity type generation prompt. In such instances the modifying comprises generating an optimized entity type generation prompt based on the one or more recommendations, and the generating the optimized entity type generation prompt comprises including one or more specific entity types relevant to the domain for a task of summarization in the entity type generation prompt.

At step 640, the entity type generation prompt, the entity relationship example generation prompt, the entity and relationship extraction prompt, or any combination thereof are modified based on the one or more recommendations. In some instances, a generative model (e.g., the fifth generative model or a seventh generative model) modifies the entity type generation prompt, the entity relationship example generation prompt, the entity and relationship extraction prompt, or any combination thereof based on the one or more recommendations.

In some instances, one or more of steps 605-640 are performed iteratively to evaluate new summaries generated using modified prompts (e.g., the entity type generation prompt, the entity relationship example generation prompt, the entity and relationship extraction prompt, or any combination thereof) and provide one or more additional recommendations (if necessary) for further optimizing/modifying the prompts to better align entities and their relationships with specified objectives.

In instances where the one or more recommendations are to improve the entity type generation prompt, the process 600 may further include: determining, by the first generative model, entity types relevant to another domain based on the optimized entity type generation prompt comprising the another domain, a persona, and a sample of another source content; generating, by the second generative model, examples of relationships among entities within the domain based on the entity relationship example generation prompt comprising the entity types and the sample of the another source content; extracting, by a third generative model, entities and their relationships from the another source content based on the entity and relationship extraction prompt comprising the entity types and the examples of relationships; generating, by the third generative model, another network graph based on the extracted entities and their relationships; and generating, by a fourth generative model, one or more summaries of the another source content based on the another source content and the network graph. However, it should be understood that such processes could be modified for instances where the one or more recommendations are to improve the entity type generation prompt, the entity relationship example generation prompt, the entity and relationship extraction prompt, or any combination thereof without departing from the spirit and scope of the present disclosure.

In some instances, one or more of the first generative model, the second generative model, the third generative model, the fourth generative model, and the sixth generative model are the same or different generative models. For example, the first generative model, the second generative model, the third generative model, the fourth generative model, and the sixth generative model may be the same generative model. In some instances, the fifth generative model is a different generative model from that of the first generative model, the second generative model, the third generative model, the fourth generative model, and the sixth generative model. In some instances, one or more of the first generative model, the second generative model, the third generative model, the fourth generative model, the sixth generative model, and the seventh generative model are the same or different generative models. In some instances, the fifth and the seventh generative model are the same generative model.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

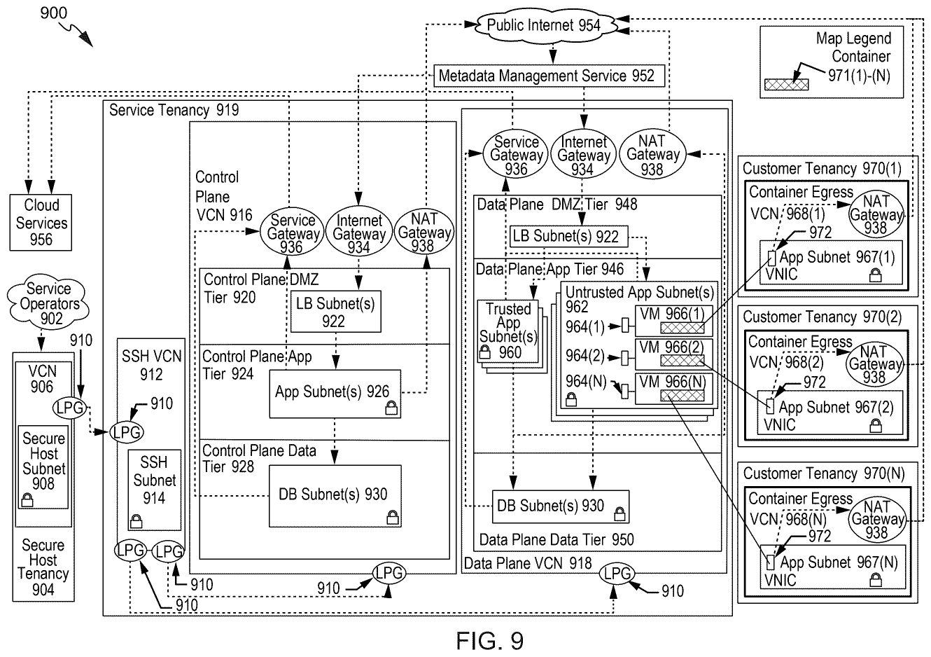

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

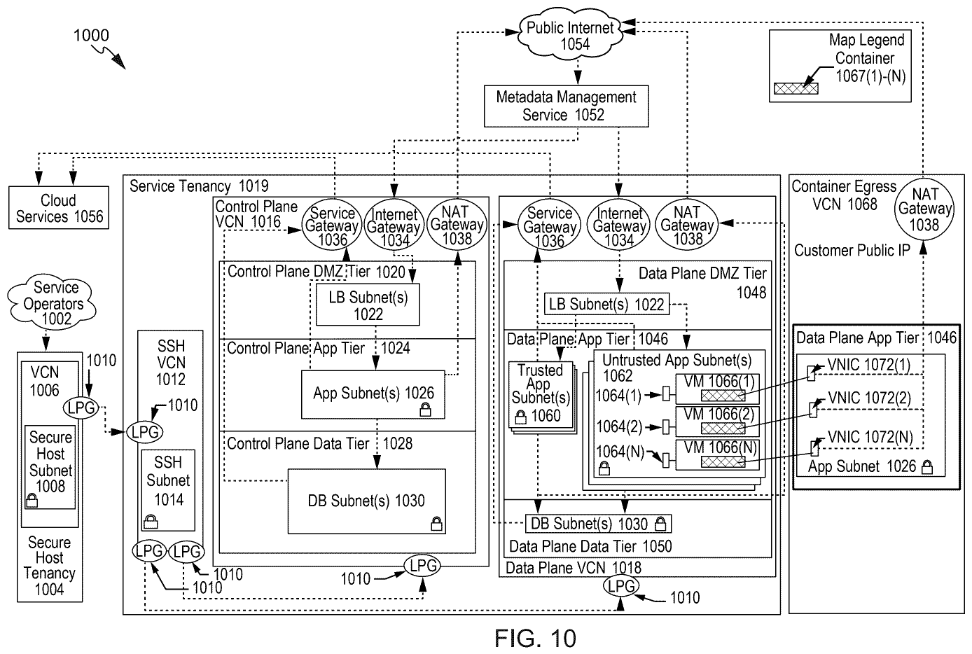

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

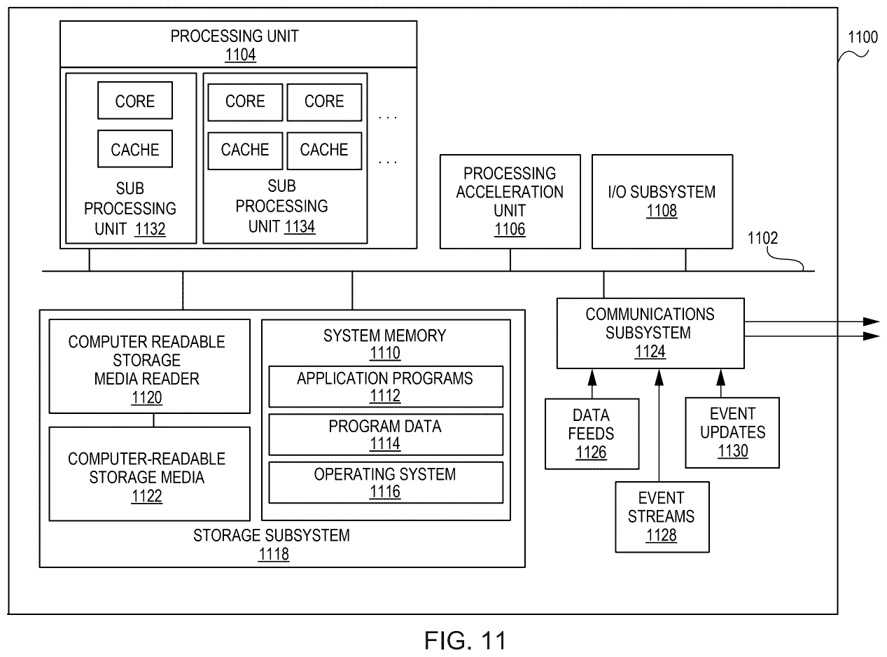

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A computer-implemented method comprising:
determining, by a first generative model, entity types relevant to a domain based on an entity type generation prompt comprising the domain, a persona, and a sample of source content;
generating, by a second generative model, examples of relationships among entities within the domain based on an entity relationship example generation prompt comprising the entity types and the sample of the source content;
extracting, by a third generative model, entities and their relationships from the source content based on an entity and relationship extraction prompt comprising the entity types and the examples of relationships;
generating, by the third generative model, a network graph based on the extracted entities and their relationships;
generating, by a fourth generative model, one or more summaries of the source content based on the source content and the network graph;
evaluating, by a fifth generative model and based on an optimizer prompt and objective function, the generated one or more summaries against ground truth summaries;
generating, by the fifth generative model, one or more recommendations to improve the entity type generation prompt, the entity relationship example generation prompt, the entity and relationship extraction prompt, or any combination thereof to align entities and their relationships with specified objectives; and
modifying the entity type generation prompt, the entity relationship example generation prompt, the entity and relationship extraction prompt, or any combination thereof based on the one or more recommendations.

2. The computer-implemented method of claim 1, further comprising generating, by a sixth generative model, the domain and the persona for the sample of the source content based on a domain and persona generation prompt comprising the sample of source content.

3. The computer-implemented method of claim 1, wherein one or more of the first generative model, the second generative model, the third generative model, the fourth generative model, and the sixth generative model are the same or different generative models.

4. The computer-implemented method of claim 1, wherein the first generative model, the second generative model, the third generative model, the fourth generative model, and the sixth generative model are the same generative model.

5. The computer-implemented method of claim 1, wherein the objective function is expressed as a set of instructions within the optimizer prompt, and wherein the set of instructions cause the fifth generative model to compare the generated one or more summaries against ground truth summaries and analyze performance of the third generative model to extract the entities and their relationships from the source content based on the compare.

6. The computer-implemented method of claim 5, wherein analyzing the performance of the third generative model may include identifying errors in extracting the entities and their relationships from the source content based on the comparing and with attention to improving one or more metrics for measuring quality of the one or more summaries.

7. The computer-implemented method of claim 6, wherein the one or more metrics include comprehensiveness, directness, completeness, conciseness, or any combination thereof.

8. The computer-implemented method of claim 6, wherein the set of instructions further cause the fifth generative model to generate instructions, based on the analyzing and the one or more metrics, as the one or more recommendations to improve the entity type generation prompt, the entity relationship example generation prompt, the entity and relationship extraction prompt, or any combination thereof to align entities and their relationships with the specified objectives.

9. The computer-implemented method of claim 8, wherein the one or more recommendations are to improve the entity type generation prompt, the modifying comprises generating an optimized entity type generation prompt based on the one or more recommendations, and the generating the optimized entity type generation prompt comprises including one or more specific entity types relevant to the domain for a task of summarization in the entity type generation prompt.

10. The computer-implemented method of claim 9, further comprising:
determining, by the first generative model, entity types relevant to another domain based on the optimized entity type generation prompt comprising the another domain, a persona, and a sample of another source content;
generating, by the second generative model, examples of relationships among entities within the domain based on the entity relationship example generation prompt comprising the entity types and the sample of the another source content;
extracting, by a third generative model, entities and their relationships from the another source content based on the entity and relationship extraction prompt comprising the entity types and the examples of relationships;
generating, by the third generative model, another network graph based on the extracted entities and their relationships; and
generating, by a fourth generative model, one or more summaries of the another source content based on the another source content and the network graph.

11. A system comprising:
one or more processing systems; and
one or more computer-readable media storing instructions which, when executed by the one or more processing systems, cause the system to perform operations comprising:
determining, by a generative model, entity types relevant to a domain based on an entity type generation prompt comprising the domain, a persona, and a sample of source content;
generating, by the generative model, examples of relationships among entities within the domain based on an entity relationship example generation prompt comprising the entity types and the sample of the source content;
extracting, by the generative model, entities and their relationships from the source content based on an entity and relationship extraction prompt comprising the entity types and the examples of relationships;
generating, by the generative model, a network graph based on the extracted entities and their relationships;
generating, by the generative model, one or more summaries of the source content based on the source content and the network graph;
evaluating, by another generative model and based on an optimizer prompt and objective function, the generated one or more summaries against ground truth summaries;
generating, by the another generative model, one or more recommendations to improve the entity type generation prompt, the entity relationship example generation prompt, the entity and relationship extraction prompt, or any combination thereof to align entities and their relationships with specified objectives; and
modifying the entity type generation prompt, the entity relationship example generation prompt, the entity and relationship extraction prompt, or any combination thereof based on the one or more recommendations.

12. The system of claim 11, wherein the objective function is expressed as a set of instructions within the optimizer prompt, and wherein the set of instructions cause the another generative model to compare the generated one or more summaries against ground truth summaries and analyze performance of the generative model to extract the entities and their relationships from the source content based on the compare.

13. The system of claim 12, wherein analyzing the performance of the generative model may include identifying errors in extracting the entities and their relationships from the source content based on the comparing and with attention to improving one or more metrics for measuring quality of the one or more summaries.

14. The system of claim 13, wherein the one or more metrics include comprehensiveness, directness, completeness, conciseness, or any combination thereof.

15. The system of claim 13, wherein the set of instructions further cause the another generative model to generate instructions, based on the analyzing and the one or more metrics, as the one or more recommendations to improve the entity type generation prompt, the entity relationship example generation prompt, the entity and relationship extraction prompt, or any combination thereof to align entities and their relationships with the specified objectives.

16. The computer-implemented method of claim 15, wherein the one or more recommendations are to improve the entity type generation prompt, the modifying comprises generating an optimized entity type generation prompt based on the one or more recommendations, and the generating the optimized entity type generation prompt comprises including one or more specific entity types relevant to the domain for a task of summarization in the entity type generation prompt.

17. One or more non-transitory computer-readable media storing instructions which, when executed by one or more processors, cause a system to perform operations comprising:
determining, by a first generative model, entity types relevant to a domain based on an entity type generation prompt comprising the domain, a persona, and a sample of source content;
generating, by a second generative model, examples of relationships among entities within the domain based on an entity relationship example generation prompt comprising the entity types and the sample of the source content;
extracting, by a third generative model, entities and their relationships from the source content based on an entity and relationship extraction prompt comprising the entity types and the examples of relationships;
generating, by the third generative model, a network graph based on the extracted entities and their relationships;
generating, by a fourth generative model, one or more summaries of the source content based on the source content and the network graph;
evaluating, by a fifth generative model and based on an optimizer prompt and objective function, the generated one or more summaries against ground truth summaries;
generating, by the fifth generative model, one or more recommendations to improve the entity type generation prompt, the entity relationship example generation prompt, the entity and relationship extraction prompt, or any combination thereof to align entities and their relationships with specified objectives; and
modifying the entity type generation prompt, the entity relationship example generation prompt, the entity and relationship extraction prompt, or any combination thereof based on the one or more recommendations.

18. The one or more non-transitory computer-readable media of claim 17, wherein one or more of the first generative model, the second generative model, the third generative model, the fourth generative model, and the sixth generative model are the same or different generative models.

19. The one or more non-transitory computer-readable media of claim 17, wherein the first generative model, the second generative model, the third generative model, the fourth generative model, and the sixth generative model are the same generative model.

20. The one or more non-transitory computer-readable media of claim 17, wherein the objective function is expressed as a set of instructions within the optimizer prompt, and wherein the set of instructions cause the fifth generative model to compare the generated one or more summaries against ground truth summaries and analyze performance of the third generative model to extract the entities and their relationships from the source content based on the compare.
